(19) United States
(12) Patent Application Publication
(10) Pub. No.: US 2008/0208506 A1
(43) Pub. Date: Aug. 28, 2008

(54) FOCUS DETECTION DEVICE, IMAGING APPARATUS, METHOD FOR MANUFACTURING A FOCUS DETECTION DEVICE AND FOCUS DETECTION METHOD

(75) Inventor: Chiyuki KUWATA, Shinagawa-ku (JP)

Correspondence Address: DITTHAVONG MORI & STEINER, P.C., 918 Prince St., Alexandria, VA, 22314, US

(73) Assignee: Nikon Corporation, Tokyo (JP)

(21) Appl. No.: 12/038,750

(22) Filed: Feb. 27, 2008

(30) Foreign Application Priority Data
Feb. 27, 2007 (JP) 2007-047524

(51) Int. Cl. G01D 18/00

(52) U.S. Cl. 702/104

(57) ABSTRACT

A focus detection device comprises a micro-lens array constituted of a plurality of micro-lenses that are two-dimensionally arrayed on a lens arrangement plane of the micro-lenses; a light-receiving element array that includes a plurality of light-receiving elements disposed in correspondence to each micro-lens, and that receives a light flux from an imaging optical system via the micro-lenses; and a focus detection calculation unit that calculates a focal adjustment state of the imaging optical system based-upon light reception signals output from the light-receiving elements at the light-receiving element array, wherein: arrangement of the micro-lenses are different with each other in correspondence to area on the lens arrangement plane of the micro-lens array.

### INCORPORATION BY REFERENCE

The disclosure of the following priority application is herein incorporated by reference:

Japanese Patent Application No. 2007-047524 filed Feb. 27, 2007

### BACKGROUND OF THE INVENTION

1. Field of the Invention

The present invention relates to a focus detection device, an imaging apparatus, a method for manufacturing a focus detection device and a focus detection method.

2. Description of Related Art

Japanese Laid Open Patent Publication No. S58-024105 discloses a focus detection device that executes focus detection for a photographic lens through a phase difference detection method by receiving light transmitted through the photographic lens at a micro-lens array constituted with two dimensionally disposed micro-lenses and a photoelectric conversion element array constituted with a plurality of photoelectric conversion elements disposed to the rear of each micro-lens.

### SUMMARY OF THE INVENTION

There is an issue to be addressed in the focus detection device in the related art with micro-lenses disposed in a two-dimensional square array in that a detection error occurs due to an aberration of the photographic lens over a peripheral focus detection area away from the center of the predetermined focal plane of the photographic lens, through which the optical axis of the photographic lens passes.

A focus detection device according to the present invention comprises a micro-lens array constituted of a plurality of micro-lenses that are two-dimensionally arrayed on a lens arrangement plane of the micro-lenses; a light-receiving element array that includes a plurality of light-receiving elements disposed in correspondence to each micro-lens, and that receives a light flux from an imaging optical system via the micro-lens; and a focus detection calculation unit that calculates a focal adjustment state of the imaging optical system based upon light reception signals output from the light-receiving elements at the light-receiving element array, and in this focus detection device arrangements of the micro-lenses are different with each other in correspondence to area on a lens arrangement plane of the micro-lens array.

It is desirable that in the focus detection device described above, the micro-lens array and the light-receiving element array are disposed in correspondence to an image plane provided via the imaging optical system; and the micro-lenses are disposed along at least one of a radial direction extending from a center of the image plane and a direction perpendicular to the radial direction extending from the center in each of a plurality of areas defined by partitioning corresponding the lens arrangement plane of the micro-lens array. In this case, it is desirable that arrangements of the light-receiving elements in the light-receiving element array are different with each other in correspondence to area on an element arrangement plane of the light-receiving element array. At the focus detection device, the light-receiving elements can be disposed along at least one of a radial direction extending from a center of the image plane and a direction perpendicular to the radial direction extending from the center in each of a plurality of areas defined by partitioning corresponding the element arrangement plane of the light-receiving elements.

At the focus detection device according to the present invention, the light-receiving elements can be disposed in matrix on an element arrangement plane irrespective of the plurality of areas.

It is desirable that at the focus detection device in which each of a plurality of areas defined by partitioning the lens arrangement plane of the micro-lens array, the plurality of areas are partitioned by a partitioning line extending along the radial direction extending from the center of the image plane.

It is desirable that the focus detection calculation unit determines the focal adjustment state based upon outputs of a plurality of light-receiving elements disposed along at least one of a radial direction extending from a center of an image plane and a direction perpendicular to the radial direction extending from the center, among the plurality of light-receiving elements corresponding to each micro-lens.

At the focus detection device according to the present invention, the plurality of light-receiving elements corresponding to each micro-lens includes a pair of light-receiving elements along an array direction of micro-lenses; and the focus detection calculation unit determines the focal adjustment state based upon a pair of outputs from a plurality of light-receiving elements. Furthermore, the focus detection calculation unit can determines the focal adjustment state based upon the pair of outputs from a plurality of light-receiving element sets with translational symmetry along one of the radial direction extending from the center of the image plane and the direction perpendicular to the radial direction extending from the center, among the plurality of light-receiving elements included in the light-receiving elements corresponding to each micro-lens.

A focus detection device according to another aspect of the invention, comprises: a micro-lens array constituted with a plurality of micro-lens groups including a plurality of micro-lenses two-dimensionally arrayed; a light-receiving element array that includes a plurality of light-receiving elements disposed in correspondence to micro-lens array, and that receives a light flux from an imaging optical system via the micro-lens array; and a focus detection calculation unit that calculates a focal adjustment state of the imaging optical system based upon light reception signals output from the light-receiving elements at the light-receiving element array, and in this focus detection device, in part of the plurality of the micro-lens groups, the micro-lenses are disposed in a different arrangement.

A focus detection device according to another aspect of the invention, comprises: a micro-lens array constituted with a plurality of micro-lenses that are two-dimensionally arrayed on a lens arrangement plane of the micro-lens array; a light-receiving element array that includes a plurality of light-receiving elements disposed in matrix, which receives a light flux from an imaging optical system via the micro-lenses; and a focus detection calculation unit that calculates a focal adjustment state of the imaging optical system based upon light reception signals output from the light-receiving elements at the light-receiving element array, and in this focus detection device arrangements of the micro-lenses are different with each other in correspondence to area on a lens arrangement plane of the micro-lens array. It is desirable that at the focus detection device, the micro-lens array and the light-receiving element array are disposed in correspondence to an image plane provided via the imaging optical system; and in this focus detection device the focus detection calculation unit determines the focal adjustment state based upon a plurality of the light reception signals selected along one of a radial direction extending from a center of the image plane and a direction perpendicular to the radial direction extending from the center in correspondence to each of a plurality of areas defined by dividing an element arrangement plane of the light-receiving element array.

An imaging apparatus according to the invention, comprises the focus detection device described above. It is desirable that the imaging apparatus further comprises: a detecting unit that generates image data by using light reception signals from the light-receiving elements and detects a position of characteristic portion in an image corresponding to the image data, and in this imaging apparatus the focus detection calculation unit determines the focal adjustment state of the imaging optical system based upon light reception signals from the light-receiving elements corresponding to the position of the characteristic portion in the image.

A method for manufacturing a focus detection device according to the present invention, comprises: providing a light-receiving element array that includes a plurality of light-receiving elements disposed in matrix, which receives a light flux from an imaging optical system; providing micro-lens array constituted of a plurality of micro-lenses that are two-dimensionally arrayed on a lens arrangement plane of the micro-lenses, arrangements of the micro-lenses being different with each other in correspondence to area on the lens arrangement plane of the micro-lens array; disposing a plurality of the light-receiving elements on the light-receiving element array corresponding to each the micro-lenses; and providing a calculation circuit calculating a focal adjustment state of the imaging optical system based upon light reception signals output from the light-receiving elements at the light-receiving element array.

It is desirable that in the method for manufacturing a focus detection device described above, the micro-lens array and the light-receiving array are disposed in corresponding to an image plane provided via the imaging optical system; and the micro-lenses are disposed along at least one of a radial direction extending from a center of the image plane and a direction perpendicular to the radial direction extending from the center in each of a plurality of areas defined by partitioning corresponding the lens arrangement plane of the micro-lens array. It is desirable that in the method for manufacturing a focus detection device arrangements of the light-receiving elements in the light-receiving element array are different with each other in correspondence to area on an element arrangement plane of the light-receiving element array. Furthermore, it is desirable that in the method for manufacturing a focus detection device the light-receiving elements are disposed along at least one of a radial direction extending from a center of the image plane and a direction perpendicular to the radial direction extending from the center in each of a plurality of areas defined by partitioning corresponding the element arrangement plane of the light-receiving elements.

A focus detection method according to the present invention by means of the focus detection device described above, comprises: determining the focal adjustment state based upon outputs of a plurality of light-receiving elements disposed along at least one of a radial direction extending from a center of an image plane and a direction perpendicular to the radial direction extending from the center, among the plurality of light-receiving elements corresponding to each micro-lens. It is desirable that in the focus detection method the focal adjustment state is determined based upon a pair of outputs from a plurality of light-receiving elements, the pair of outputs being in correspondence to a pair of light-receiving elements corresponding to each micro-lens along an array direction of micro-lenses.

It is desirable that in the focus detection method described above, the focal adjustment state is determined based upon the pair of outputs from a plurality of light-receiving element sets with translational symmetry along one of the radial direction extending from the center of the image plane and the direction perpendicular to the radial direction extending from the center, among the plurality of light-receiving elements included in the light-receiving elements corresponding to each micro-lens. Furthermore, it is desirable that the focus detection method described above further comprises: generating image data by using light reception signals from the light-receiving elements; and detecting a position of characteristic portion in an image corresponding to the image data; and in this method the focal adjustment state of the imaging optical system is determined based upon light reception signals from the light-receiving elements corresponding to the position of the characteristic portion in the image.

### BRIEF DESCRIPTION OF THE DRAWINGS

FIG. 1 shows the structure of a single lens reflex digital camera equipped with the focus detection device in an embodiment;

FIG. 2 illustrates in detail the structures of the focus detection optical system and the focus detection sensor, as well as a focus detection calculation method that may be adopted in conjunction with them;

FIG. 3 illustrates in detail the structures of the focus detection optical system and the focus detection sensor, as well as a focus detection calculation method that may be adopted in conjunction with them;

FIG. 4 presents an example of a pixel array pattern that may be adopted at the micro-lens array (focus detection optical system) and the focus detection sensor;

FIG. 5 shows how separate detection areas may be designated at the micro-lens array (focus detection optical system) and the focus detection sensor;

FIG. 6 presents an enlarged view of an arrangement of the micro-lenses and the light-receiving elements assumed within a detection area at the focus detection device shown in FIG. 4;

FIG. 7 presents another example of a detection area partition that may be adopted at the micro-lens array (focus detection optical system) and the focus detection sensor;

FIG. 8 presents another example of a pixel array pattern that may be adopted at the micro-lens array (focus detection optical system) and the focus detection sensor;

FIG. 9 presents yet another example of a pixel array pattern that may be adopted at the micro-lens array (focus detection optical system) and the focus detection sensor;

FIG. 10 presents an enlarged view of an arrangement of the micro-lenses and the light-receiving elements assumed within a detection area;

FIG. 11 presents an enlarged view of arrangements of the micro-lenses and the light-receiving elements assumed within detection areas;

FIG. 12 presents an enlarged view of arrangements of the micro-lenses and the light-receiving elements assumed within detection areas;

FIG. 13 presents an enlarged view of an arrangement of the micro-lenses and the light-receiving elements assumed within a detection area;

FIG. 14 presents an enlarged view of arrangements of the micro-lenses and the light-receiving elements assumed within detection areas;

FIG. 15 presents an enlarged view of a micro-lens/light-receiving element group;

FIG. 16 presents an enlarged view of a micro-lens/light-receiving element group;

FIG. 17 presents an enlarged view of arrangements of the micro-lenses and the light-receiving elements assumed within detection areas;

FIG. 18 presents an enlarged view of arrangements of the micro-lenses and the light-receiving elements assumed within detection areas;

FIG. 19 presents an enlarged view of arrangements of the micro-lenses and the light-receiving elements assumed within detection areas; and

FIG. 20 presents another example of a detection area partition that may be adopted at the micro-lens array (focus detection optical system) and the focus detection sensor.

### DESCRIPTION OF PREFERRED EMBODIMENT

An embodiment adopting the present invention in a single lens reflex digital camera is described below. It is to be noted that the application of the present invention is not limited to single lens reflex digital cameras and it may be adopted in any type of imaging apparatus at which focal adjustment is executed for the photographic lens.

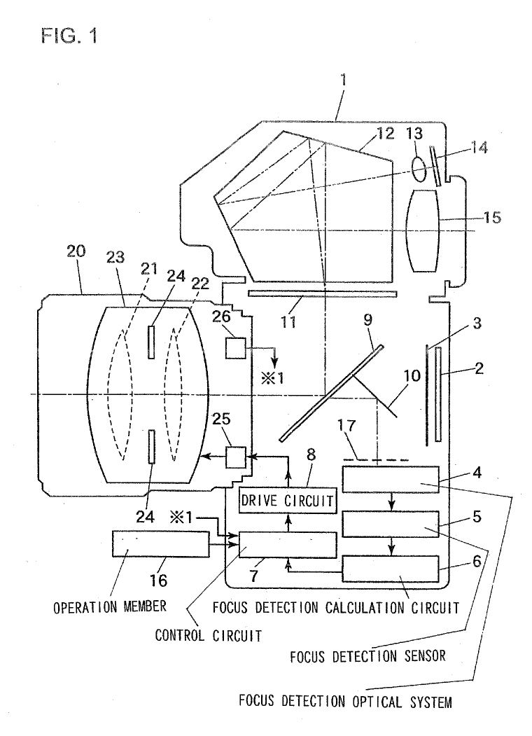

FIG. 1 is a lateral sectional view showing the structure of a single lens reflex digital camera equipped with the focus detection device in an embodiment. It is to be noted that an illustration and an explanation of standard components and devices in the camera, which do not bear direct relevance to the focus detection device and the imaging apparatus according to the present invention, are omitted. At the camera in the embodiment, a lens barrel 20 is interchangeably mounted at the camera body 1. It is to be noted that while an explanation is given in reference to the embodiment on an example in which the present invention is adopted in the camera that allows the use of an interchangeable lens, the present invention is not limited to applications in cameras with interchangeable lenses and may be adopted in a camera with a fixed lens.

At the camera body 1, an image sensor 2, a shutter 3, a focus detection optical system 4, a focus detection sensor 5, a focus detection calculation circuit 6, a camera control circuit 7, a drive circuit 8, a quick-return mirror 9, a sub mirror 10, a viewfinder screen 11, a pentaprism 12, a photometering lens 13, a photometering sensor 14, an eyepiece lens 15, an operation member 16 and the like are disposed.

The image sensor 2, constituted with a CCD, a CMOS or the like, converts a subject image formed through an imaging lens 23 disposed within the lens barrel 20 to electrical signals and outputs the signals resulting from the conversion. As the shutter button (not shown) is pressed all the way down (at the time of a shutter release) the shutter 3 is released over a length of time matching a shutter speed set based upon exposure calculation results or set manually by the photographer so as to expose the image sensor 12 with light passing through the shutter 3. The focus detection optical system 4, the focus detection sensor 5 and the focus detection calculation circuit 6 constitute a focus detection device adopting a phase difference detection method that detects a defocus amount indicating the focal adjustment state at the photographic lens 23. The components 4, 5 and 6 constituting the focus detection device are to be described in detail later.

The camera control circuit 7, constituted with a microcomputer and its peripheral components such as a memory (none shown), controls sequences including a photometering sequence, a focus detection sequence and a photographing sequence, as well as arithmetic operations such as the exposure calculation. The drive circuit 8 controls drive of an actuator 25 disposed within the lens barrel 20. The photometering sensor 14 outputs a photometering signal corresponding to the brightness in each of a plurality of areas defined by dividing the photographic image plane.

At the lens barrel 20, a focusing lens 21, a zoom lens 22, an aperture 24, the actuator 25, a lens memory 26 and the like are disposed. It is to be noted that FIG. 1 shows a single photographic lens 23 representing both the focusing lens 21 and the zooming lens 22. As the focusing lens 21 is driven along the optical axis by the actuator 25, the focal point of the photographic lens 23 is adjusted. As the zooming lens 22 is driven along the optical axis by the actuator 25, the focal length of the photographic lens 23 is adjusted. As the aperture 24 is driven by the actuator 25, the aperture opening diameter is altered. In the lens memory 26, information related to the photographic optical system, such as the F value, the focal length and an aperture threshold value Fk (to be detailed later) of the photographic lens 23, is stored.

The operation member 16 operated by the photographer is disposed at the camera body 1 and the lens barrel 20. The operation member 16 includes a shutter release halfway press switch which enters an ON state when the shutter button is pressed halfway down and a shutter release full press switch which enters in ON state when the shutter button is pressed all the way down.

As shown in FIG. 1, the quick return mirror 9 and the sub mirror 10 are set within the photographic light path in a non-photographing state. In this state, part of the light from the subject, having been transmitted through the photographic lens 23, is reflected at the quick return mirror 9 and is guided to the viewfinder screen 11 to form a subject image on the screen 11. The subject image is guided toward the photographer's eye via the pentaprism 12 and the eyepiece lens 15 and is also guided to the photometering sensor 14 via the pentaprism 12 and the photometering lens 13. The camera control circuit 7 executes exposure calculation based upon photometering signals output from the photometering sensor 14 in correspondence to the individual photometering areas so as to calculate the shutter speed and the aperture value corresponding to the brightness in the photographic field. It is to be noted that the exposure calculation is executed based upon the shutter speed and the aperture value set by the photographer by operating the operation member 16 in a manual exposure photographing mode.

Another portion of the light from the subject having passed through the photographic lens 23 is transmitted through the quick return mirror 9, is reflected at the sub mirror 10 and is guided to the focus detection sensor 5 via the focus detection optical system 4. Focus detection areas are set at a plurality of positions within the photographic image plane and the focus detection sensor 5 outputs a focus detection signal indicating the focal adjustment state of the photographic lens 23 in correspondence to each focus detection area in the embodiment. The focus detection calculation circuit 6 calculates the defocus amount indicating the focal adjustment state of the photographic lens 23 based upon the focus detection signal output in correspondence to each focus detection area. The camera control circuit 7 calculates the lens drive quantity based upon the defocus amount and drives the actuator 25 via the drive circuit 8 so as to drive the focusing lens 21 to the focus much position.

In the photographing state, the quick return mirror 9 and the sub mirror 10 are made to retreat from the photographic light path (mirror up), the shutter 3 is released and the light flux from the subject having been transmitted through the photographic lens 23 is guided to the image sensor 2 enabling the image sensor 2 to capture the image.

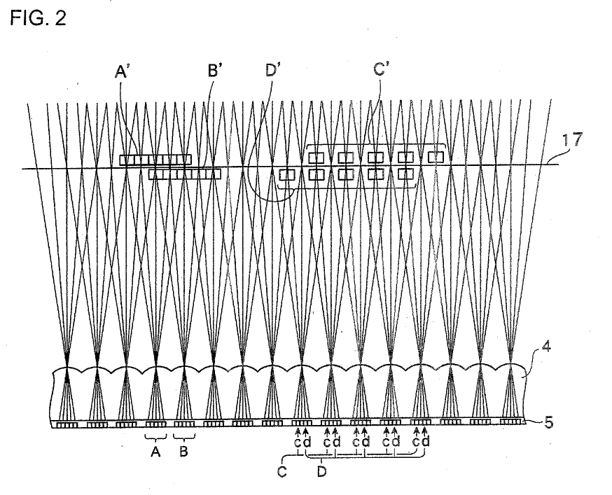

FIG. 2 shows in detail the structures adopted in the focus detection optical system 4 and the focus detection sensor 5. The focus detection optical system 4 constituted with a micro-lens array having a plurality of micro-lenses disposed over a two-dimensional plane (a lens arrangement plane), is set at a position to the rear of a predetermined focal plane 17 of the photographic lens 23 by a specific distance, as shown in FIG. 1. The focus detection sensor 5 is disposed behind the micro-lens array (focus detection optical system) 4 in close contact with the micro-lens array 4. The focus detection sensor 5, constituted with a light-receiving element array having a plurality of light-receiving elements (photoelectric conversion elements) included in a plurality of light-receiving element sets disposed over a two-dimensional plane (an element arrangement plane), includes five light-receiving elements as a light-receiving element set disposed in correspondence to each micro-lens in the embodiment. It is to be noted that various modes that may be adopted with regard to the arrangement of the micro-lenses and the light-receiving elements and their correspondence are to be described later.

For purposes of simplification, a set of a micro-lens and the corresponding light-receiving element group is referred to as a pixel in the description. In the example presented in FIG. 2, a single pixel is constituted with a micro-lens and five light-receiving elements disposed in correspondence to the micro-lens. The focus detection device in the embodiment adopts a structure in which the image of the light-receiving element group at each pixel is formed via the corresponding micro-lens at a position further toward the subject relative to the apex of the micro-lens and the micro-lens array (focus detection optical system) 4 and the focus detection sensor 5 are disposed so as to align the image forming plane with the predetermined focal plane 17.

The focus detection device 4 through 6 in the embodiment adopts a phase difference detection method whereby a defocus amount is determined based upon a positional shift near the detection plane by a pair of images formed with subject light fluxes having passed through different areas at the pupil plane of the photographic lens 23.

Focus detection calculation methods that may be adopted in the focus detection calculation circuit 6 in the embodiment are now explained. The focus detection calculation circuit 6 adopting a first focus detection calculation method calculates the defocus amount based upon the extent of shift manifested by images detected at the light-receiving element groups of adjacent pixels or pixels set apart from each other by a predetermined distance. For instance, the defocus amount may be calculated based upon the extent of shift between images on the two light-receiving element rows (rows A and B) corresponding to two adjacent pixels, i.e., based upon the extent of shift of subject images formed via the photographic lens 23 at positions assumed by “reverse-projected images of the light-receiving element rows A and B”, indicated by A′ and B′ on the predetermined focal plane 17 in FIG. 2 through this method.

The focus detection calculation circuit 6 adopting a second focus detection calculation method calculates the defocus amount based upon the extent of shift between an image generated by stringing together the outputs from nth light-receiving elements counting from light-receiving element group ends at a plurality of successive pixels and an image generated by stringing together the outputs from (n+m)th light-receiving elements at the individual pixels. For instance, the defocus amount may be calculated based upon the extent of shift between an image represented by a light-receiving element group C formed by stringing together the outputs from the second light-receiving elements counting from the left ends of the light-receiving element rows at the individual pixels and an image represented by a light-receiving element group D formed by stringing together the outputs from the fourth light-receiving elements d counting from the left ends of the individual light-receiving element rows in FIG. 2 through this method. Namely, the focus detection calculation circuit 6 calculates the defocus amount based upon the extent of shift manifested by subject images formed through the photographic lens 23 at positions assumed by “reverse-projected images of the light-receiving element groups C and D”, indicated by C′ and D′ on the predetermined focal plane 17.

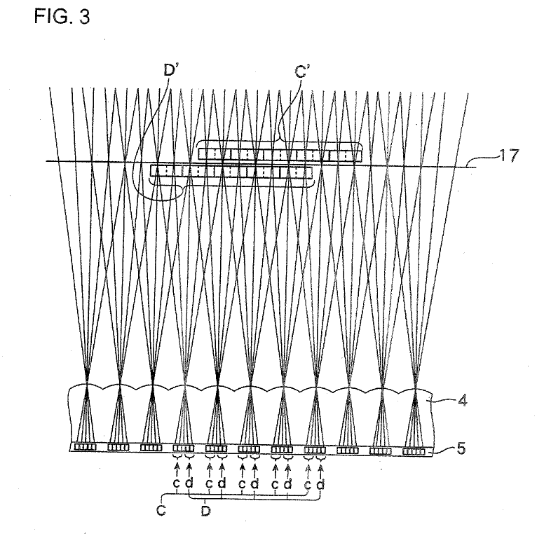

It is to be noted that a variation of the second focus detection calculation method, whereby the defocus amount is calculated based upon the extent of shift manifested by an image represented by a light-receiving element group C formed by stringing together the sums of the outputs from the first and second light-receiving elements counting from the left end and an image represented by a light-receiving element group D formed by stringing together the sums of the outputs from the fourth and fifth light-receiving elements counting from the left ends, as shown in FIG. 3, may be adopted instead. In this case, the focus detection calculation circuit 6 calculates the defocus amount based upon the extent of shift between subject images formed via the photographic lens 23 at positions assumed by “reverse-projected images of the light-receiving element groups C and D”, indicated by C′ and D′ on the predetermined focal plane 17.

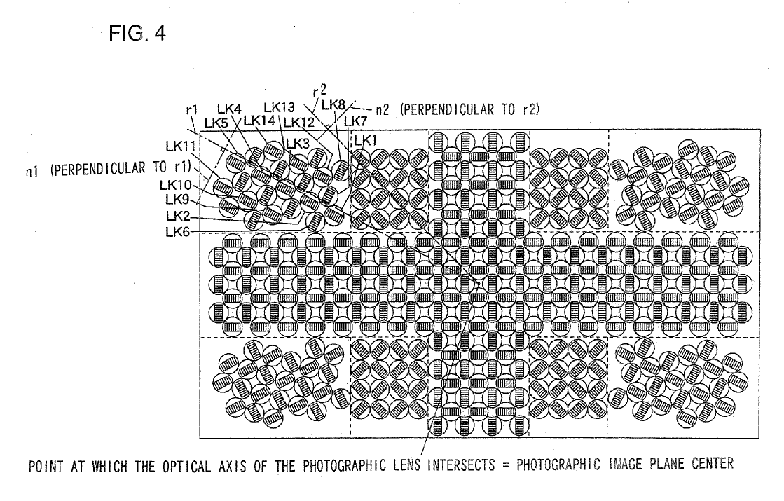

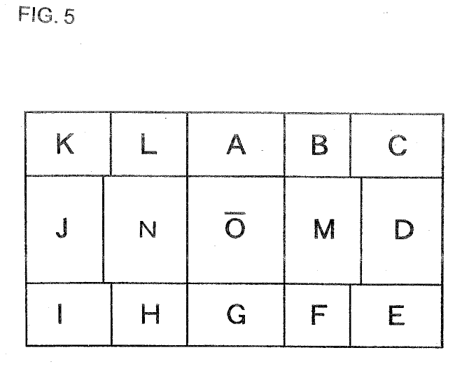

FIG. 4 presents an example of a pixel array that may be adopted in the micro-lens array (focus detection optical system) 4 and the focus detection sensor 5, viewed from the predetermined focal plane 17 in FIG. 1. While the areas between individual micro-lenses are covered by a light-blocking film, an illustration of the light-blocking film is omitted in FIG. 4 for purposes of simplification. It is to be noted that the pixel array in FIG. 4, constituted with the micro-lens array 4 and the focus detection sensor 5, is divided into 15 detection areas A through O, as shown in FIG. 5, with the boundaries between the individual detection areas indicated by the dotted lines. In each detection area, a plurality of micro-lenses constitutes a micro-lens group.

A line segment r1 in FIG. 4 is a radial line extending from a point at which the optical axis of the photographic lens 23 (see FIG. 1) intersects the micro-lens array 4 and the focus detection sensor 5, i.e., the photographic image plane center, toward a substantial center of the detection area K. In this description, the direction along which the line segment r1 extends is referred to as a “radial direction extending from the image plane center”. In the detection area K, light-receiving element rows corresponding to micro-lenses LK1, LK2, LK3, LK4 and LK5 are all set along the direction of the line segment r1, i.e., along the radial direction extending from the image plane center. The light-receiving element rows corresponding to micro-lenses LK9 through LK11 and LK12 through LK14 are also set along the radial direction extending from the image plane center.

A micro-lens row formed with micro-lenses LK6, LK7 and LK8 and three other micro-lens rows are all set along a line segment n1 perpendicular to the line segment r1. In the description, the direction of the line segment n1 extending perpendicular to the direction of the line segment r1, i.e., perpendicular to the radial direction extending from the image plane center is referred to as a “direction perpendicular to the radial direction extending from the image plane center”. The light-receiving element rows corresponding to the individual micro-lenses disposed along this direction, too, are set along the direction perpendicular to the radial direction extending from the image plane center.

Likewise, micro-lenses and the corresponding light-receiving element rows are set along a line segment r2 running along a radial direction extending from the image plane center and along a line segment n2 extending perpendicular to the radial direction extending from the image plane center. Similar positional arrangements are assumed in the detection areas I and H, the detection areas B and C and the detection areas F and E set symmetrically relative to the detection areas K and L. In other detection areas J, N, O, M, D, A and G, however, micro-lenses and the corresponding light-receiving element rows are set along the longitudinal direction or the lateral direction. Namely, on the lens arrangement plane of the micro-lens array 4, in part of the micro-lens groups, the micro-lenses are disposed in a different arrangement.

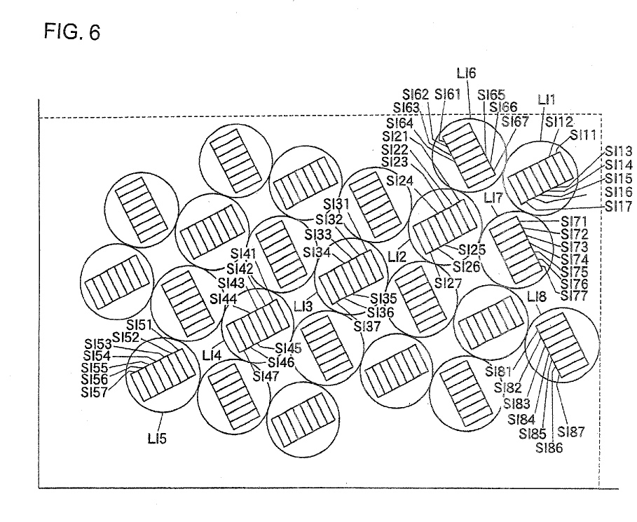

FIG. 6 presents an enlarged view of the positional arrangements of the micro-lenses and the light-receiving element rows in the detection area I in FIG. 4. An explanation is now given on the method of focus detection executed by using the micro-lenses and the light-receiving element rows in the detection area I to detect image shift manifesting along the direction perpendicular to the radial direction extending from the image plane center. The first focus detection calculation method explained earlier may be adopted in conjunction with, for instance, micro-lenses LI6 and LI7, with the light-receiving element row made up with light-receiving elements SI61 through SI67 used as an equivalent to the light-receiving element row A in FIG. 2 and the light-receiving element group made up with light-receiving elements SI71 through SI77 used as an equivalent to the light-receiving element row B in FIG. 2.

In addition, the second focus detection calculation method may be adopted in conjunction with micro-lenses LI6, LI7 and LI8, with the light-receiving element group C in FIG. 2 formed by combining the light-receiving elements SI63, SI73 and SI83 and the light-receiving element group D in FIG. 2 formed by combining the light-receiving elements SI65, SI75 and SI85.

The following advantages are achieved when image shift is detected along the direction perpendicular to the radial direction extending from the image plane center (hereafter referred to as first image shift detection).

(1) The two shifted images used in the first image shift detection achieve a relatively good match. Generally speaking, two images used for positional shift comparison, i.e., two sets of light quantity distribution detected via light-receiving element groups, are distorted due to aberration of the photographic lens through which the light has been transmitted. When the difference between the extent of distortion in the two images is more significant, the accuracy of the image shift detection is compromised to a greater extent. The extent to which aberration affects an image is largely determined by the height and the angle of the image, i.e., the relative angle formed by the direction along which the image contrast is detected and the radiating line extending from the optical axis center toward the image position. If the image shift detection direction is perpendicular to the radial direction extending from the image plane center in a substantial center of the detection area, light fluxes forming the two images are directed at positions with substantially equal image heights on the light receiving surface of the focus detection sensor 5. In addition, the direction of each image is close to the direction perpendicular to the radial direction extending from the image plane center at the position to which the corresponding light flux is directed. As a result, the aberration affects the entire images substantially uniformly, reducing the extent of mismatch between the two images attributable to the aberration. Thus, a focus detection disabled state resulting from an image mismatch does not occur readily and, at the same time, an acceptable level of focus detection accuracy can be sustained. It is to be noted that the image shift quantity detected through this method must be corrected to eliminate the error attributable to the aberration.
(2) In addition, the occurrence of vignetting in the two images can be minimized in the first image shift detection. Moreover, even if they are vignetted, the two images used for the shift comparison are vignetted with relative uniformity, and thus, the detection results are not affected significantly.

An explanation is now given on a method of focus detection executed by using the micro-lenses and the light-receiving element rows in the detection area I shown in FIG. 6 to detect image shift along the radial direction extending from the image plane center. The first focus detection calculation method explained earlier may be adopted in conjunction with, for instance, micro-lenses LI1 and LI2, with the light-receiving element rows made up with light-receiving elements SI11 through SI17 used as an equivalent to the light-receiving element row A in FIG. 2 and the light-receiving element row made up with light-receiving elements SI21 through SI27 used as an equivalent to the light-receiving element row B in FIG. 2.

In addition, the second focus detection calculation method may be adopted in conjunction with micro-lenses LI1 through LI5, with the light-receiving element group C in FIG. 2 made up by combining the light-receiving elements SI13, SI23, SI33, SI43 and SI53 and the light-receiving element group D in FIG. 2 made up by combining the light-receiving elements SI15, SI25, SI35, SI45 and SI55.

The following advantages are achieved when image shift is detected along the radial direction extending from the image plane center (hereafter referred to as second image shift detection).

(1) While a correction quantity, to be used to correct an error attributable to the aberration characteristics of the photographic lens, needs to be calculated by using data indicating the aberration characteristics, the second image shift detection is executed by taking advantage of the characteristics of the aberration, i.e., the aberration manifests in rotational symmetry around the optical axis. Namely, in the second image shift detection executed along the direction matching the radial direction extending from the image plane center in a substantial center of the detection area, a single correction quantity can be used in conjunction with a plurality of focus detection areas as long as the distances to the detection areas from the optical axis and the image lengths are equal. As a result, the correction quantity does not need to be calculated by using the data indicating the aberration inherent to the photographic lens as many times.
(2) Since the image angle does not need to be taken into consideration when calculating the correction quantity, the volume of calculation processing that must be executed to determine each correction value is reduced. Since a greater number of focus detection areas, i.e., rows at which the image shift quantity can be detected, is set in the focus detection device in the embodiment compared to a focus detection device adopting a phase difference detection method in the related art, a very significant reduction in the correction calculation burden is assured.

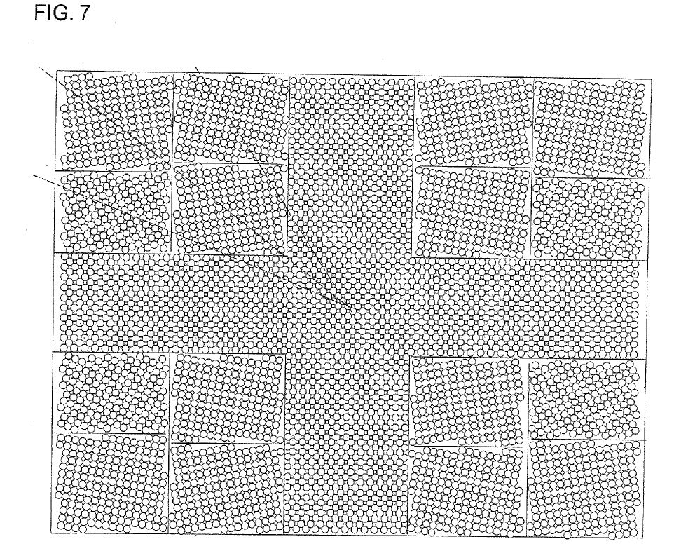

It is to be noted that the illustration of the example of the pixel array assumed for the micro-lens array (focus detection optical system) 4 and the focus detection sensor 5 presented in FIG. 4, includes a small number of detection areas with a small number of pixels disposed in each detection area for purposes of simplification. However, a greater number of detection areas are set with a greater number of pixels disposed in each detection area at the actual focus detection device, as shown in FIG. 7. If fewer pixels are disposed in the detection areas, light receiving pixel strings formed by stringing together light-receiving element outputs at the individual pixels, to be used in the second focus detection calculation method, will not have a sufficient length, which, in turn, will lower the focus detection accuracy.

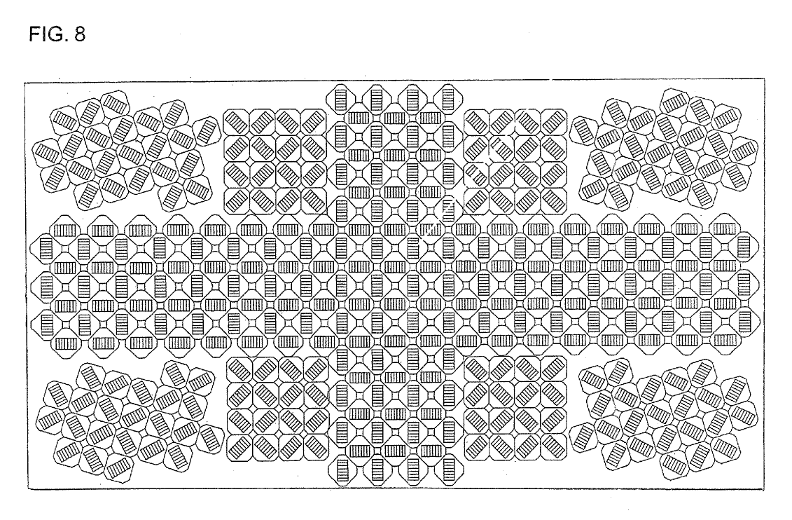

In addition, while the micro-lenses in the pixel array examples shown in FIGS. 4 and 7 have a circular outline, adjacent micro-lenses may be separated from one another at linear boundaries, as shown in FIG. 8. In the latter case, micro-lenses can be disposed at high density so as to efficiently utilize light fluxes originating from the subject.

Furthermore, in the examples of the pixel arrays shown in FIGS. 4, 7 and 8, the center of the micro-lens optical axis is aligned with the center of the corresponding light-receiving element row when viewed from the direction extending along the optical axis. However, the present invention is not limited to this example and it may be adopted in conjunction with pixels each constituted with a micro-lens and a light-receiving element group disposed so that the center of the micro-lens optical axis and the center of the light-receiving element group assume different positions. At the periphery of the photographic image plane further away from the optical axis, in particular, the range over which a light flux is directed without becoming vignetted by the photographic lens moves in parallel displacement on the light receiving plane so as to move further away from the optical axis of the photographic lens. Accordingly, efficient utilization of pixels can be assured by shifting positions of the light-receiving element groups at the focus detection sensor in correspondence to the parallel displacement so that the light-receiving element group pixels assuming positions further toward the outer periphery of the photographic image plane are shifted further toward the outside.

(Variation of the Pixel Array)

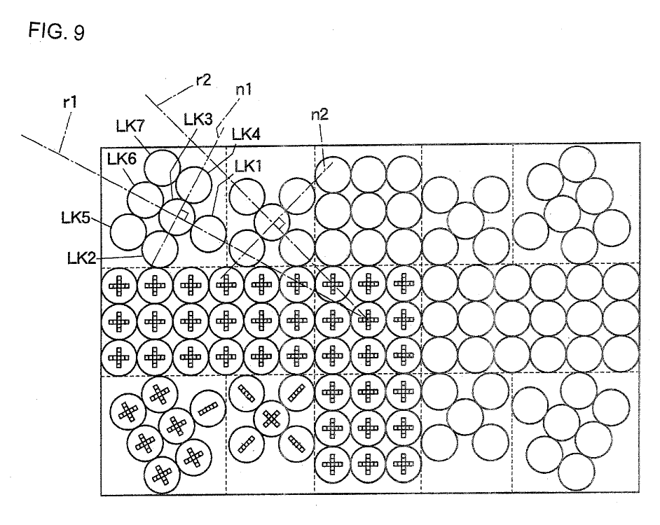

FIG. 9 presents another example of a pixel array that may be adopted for the micro-lens array (focus detection optical system) 4 and the focus detection sensor 5. The light-receiving elements disposed in correspondence to each micro-lens in this pixel array example assumes a cross-shaped pixel arrangement made up with pixel rows perpendicular to each other. This arrangement allows light-receiving element rows to be disposed at higher density than in the pixel array example explained earlier. As a result, a larger volume of information is obtained per unit area to be used in the focus detection, which, in turn, improves the focus detection accuracy while reducing the likelihood of focus detection becoming disabled.

The detection area at this pixel array constituted with the micro-lens array (focus detection optical system) 4 and the focus detection sensor 5 is also divided into 15 detection areas A through O as shown in FIG. 5. FIG. 9 does not include an illustration of the light-receiving element groups in the detection areas other than the detection areas J, N, O, I, H and G. In the upper left detection area K, a micro-lens row formed with micro-lenses LK1, LK3 and LK6 is set along the line segment r1 running in the radial direction extending from the image plane center. In addition, a row made up with micro-lenses LK2, LK3 and LK4 and a row made up with micro-lenses LK5, LK6 and LK7 are set along the line segment n1 perpendicular to the radial direction extending from the image plane center. In the detection areas L, B, C, I, H, F and E, too, micro-lenses are disposed along a line segment r2 along the radial direction extending from the image plane center and a line segment n2 running along the direction perpendicular to the radial direction extending from the image plane center.

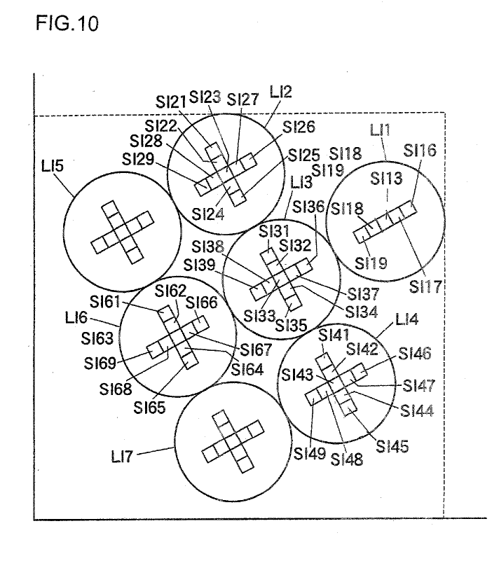

FIG. 10 presents an enlarged view of the pixel arrangement assumed within the detection area I in FIG. 9. An explanation is now given on the method of focus detection executed to detect image shift along the direction perpendicular to the radial direction extending from the image plane center (first image shift detection). The first focus detection calculation method explained earlier may be adopted in conjunction with, for instance, micro-lenses LI2 and LI3, with the light-receiving element row made up with light-receiving elements SI21 through SI25 used as an equivalent to the light-receiving element row A in FIG. 2 and the light-receiving element row made up with light-receiving elements SI31 through SI35 used as an equivalent to the light-receiving element row B in FIG. 2. In addition, the second focus detection calculation method may be adopted in conjunction with micro-lenses LI2 through LI4, with the light-receiving element group C in FIG. 2 formed by combining the light-receiving elements SI22, SI32 and SI42 and the light-receiving element group D in FIG. 2 formed by combining the light-receiving elements SI24, SI34 and SI44.

Next, focus detection executed by detecting image shift along the radial direction extending from the image plane center (second shift detection) is explained. The first focus detection calculation method explained earlier may be adopted in conjunction with, for instance, micro-lenses LI3 and LI6, with the light-receiving element row made up with light-receiving elements SI36, SI37, SI33, SI38 and SI39 used as an equivalent to the light-receiving element row A in FIG. 2 and the light-receiving element row made up with light-receiving elements SI66, SI67, SI63, SI68 and SI69 used as an equivalent to the light-receiving element row B in FIG. 2. In addition, the second focus detection calculation method may be adopted in conjunction with micro-lenses LI1, LI3 and LI6 with the light-receiving element group C in FIG. 2 formed by combining the light-receiving elements SI17, SI37 and SI67 and the light-receiving element group D in FIG. 2 formed by combining the light-receiving elements SI18, SI38 and SI68.

(Other Variations of the Pixel Array)

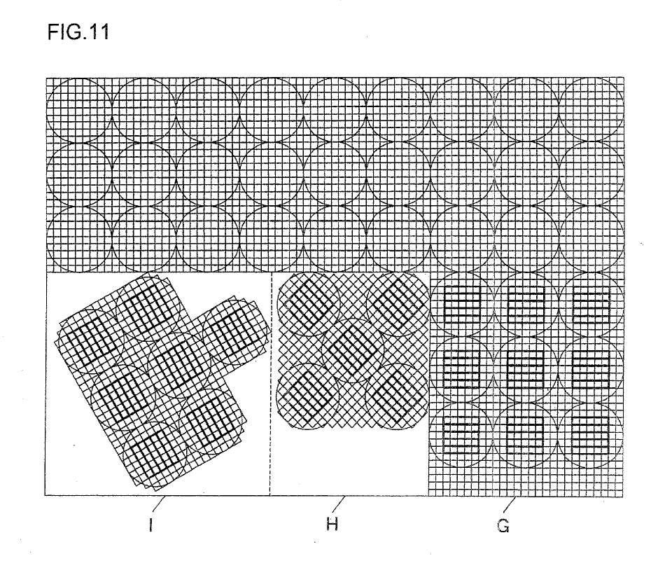

FIGS. 11 through 16 present other examples of variations that may be adopted in the pixel array. It is to be noted that while these figures only show the lower left detection areas (I, H, G) or (I, H) or a single detection area I among the detection areas A through O in FIG. 5, similar arrangements are adopted in the other detection areas as well. In these pixel arrays, light-receiving elements are disposed two-dimensionally in each detection area along the direction matching the direction in which the micro-lenses are disposed in the particular detection area. Namely, the light-receiving elements are two-dimensionally arrayed along the radial direction extending from the image plane center in a substantial center of the detection area or along the direction perpendicular to the radial direction extending from the image plane center.

For instance, the plurality of light-receiving elements corresponding to each micro-lens in the detection areas G, H and I (equivalent to G, H and I in FIG. 5) shown in FIG. 11 are divided into groups each made up with five light-receiving elements disposed along the direction perpendicular to the radial direction extending from the image plane center. The outputs from the light-receiving elements in each group are added together to be used as a single light-receiving element output in the focus detection executed along the radial direction extending from the image plane center through the first or second focus detection calculation method explained earlier. It is to be noted that FIG. 11 does not include an illustration of light-receiving element group patterns assumed in areas other than the detection areas G, H and I.

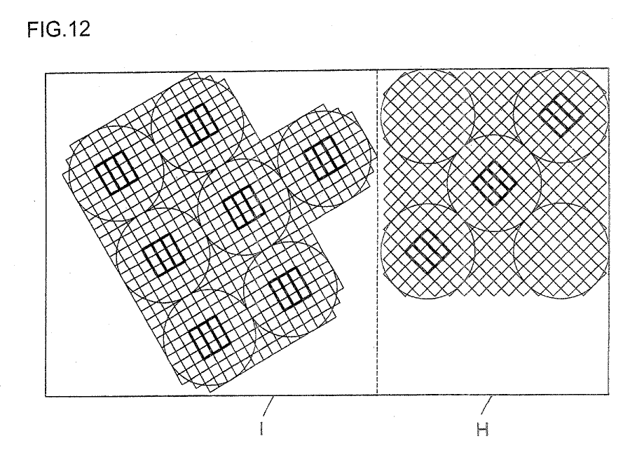

The plurality of light-receiving elements disposed under each micro-lens may be divided into groups in a manner other than that shown in FIG. 11 and any of various grouping patterns may be adopted. For instance, three light receiving pixels disposed along the direction perpendicular to the radial direction extending from the image plane center among the plurality of light-receiving elements disposed under each micro-lens, may be grouped together to constitute a single group, as shown in FIG. 12. In this case, too, the outputs from the light-receiving elements belonging to each group may be added together to be used as a single light-receiving element, which can then be used in the focus detection executed along the radial direction extending from the image plane center. In this case, this grouping pattern is particularly effective when a photographic lens with a relatively small aperture is used, since the use of the light-receiving elements disposed at the periphery through the micro-lens is able to be avoided even when light fluxes from the subject directed at the periphery of the micro-lens become vignetted, a high level of focus detection accuracy can be sustained.

In conjunction with a photographic lens with a large aperture on the other hand, the number of light-receiving elements in each group may be increased to increase the lateral dimension of the group, as shown in FIG. 11 and, in this case, since the light fluxes from the subject can be utilized in greater quantities, accurate focus detection is enabled even if the brightness of the subject is low. Accordingly, by selectively adopting the grouping method shown in FIG. 11 or FIG. 12 in correspondence to the aperture value of the photographic lens, high accuracy focus detection can be executed for various types of photographic lenses. In the pixel arrays shown in FIGS. 6 and 10, only the range of the light-receiving elements used in the focus detection, extending along the light-receiving element disposing direction, can be reduced. However, by selecting the optimal grouping method shown in FIG. 11 or FIG. 12 in correspondence to the aperture value of the photographic lens, the range extending along the direction perpendicular to the light-receiving element disposing direction, too, can be reduced.

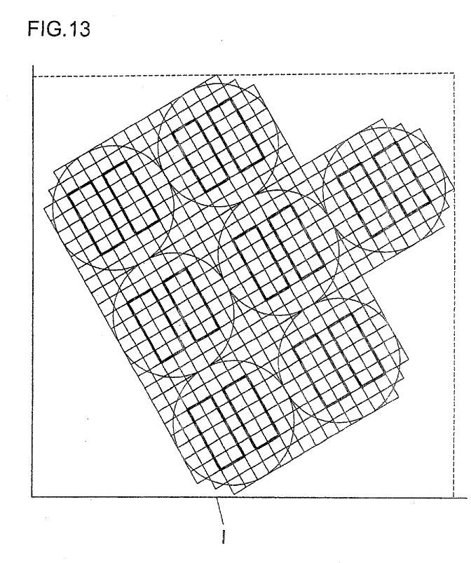

As an alternative, among the plurality of light-receiving elements corresponding to each micro-lens, a total of 10 light-receiving elements disposed over two rows (across)×five columns (down) along the direction perpendicular to the radial direction extending from the image plane center is grouped together, as shown in FIG. 13. The outputs from the light-receiving elements in the group are added together to constitute a single light-receiving element output, which can then be used in the focus detection executed along the radial direction extending from the image plane center, as explained later.

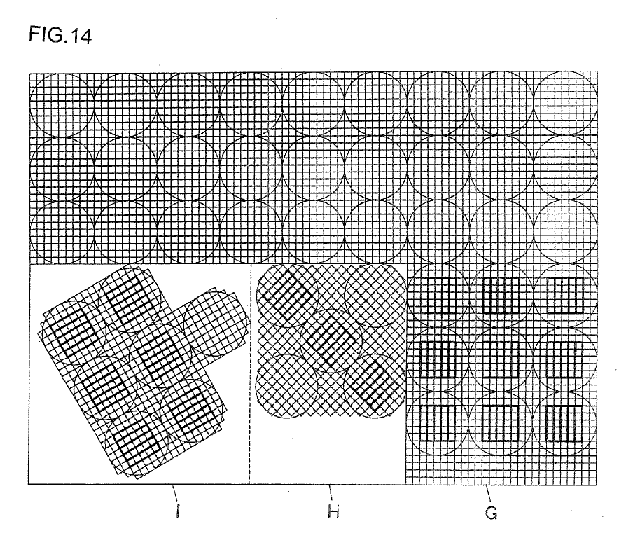

As a further alternative, among the plurality of light-receiving elements corresponding to each micro-lens in the detection areas G, H and I (equivalent to G, H and I in FIG. 5) shown in FIG. 14, five light-receiving elements disposed along the radial direction extending from the image plane center may be grouped together. In this case, too, the outputs from the light-receiving elements in the group are added together to constitute a single light-receiving element output, which can then be used in the focus detection executed along the direction perpendicular to the radial direction extending from the image plane center through the first or second focus detection calculation method explained earlier. It is to be noted that while FIG. 14 does not include an illustration of light-receiving element grouping patterns assumed in areas other than the detection areas G, H and I, a similar grouping method is assumed in the areas other than the detection areas G, H and I.

It is to be noted that the variation of the second focus detection calculation method, i.e., the focus detection calculation method wherein the outputs from a plurality of adjacent light-receiving elements are integrated and the integrated data are then extracted to be used in the focus detection, may be adopted in conjunction with the pixel arrays shown in FIGS. 11 through 14. For instance, by combining two groups in FIG. 11 to form a large group made up with light-receiving elements disposed over two rows (across)×two columns (down) as shown in FIG. 13, “group strings” equivalent to the light-receiving element groups C and D in FIG. 3 can be generated.

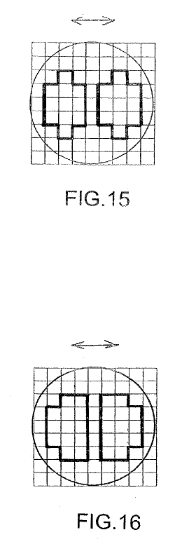

In addition, a plurality of light-receiving elements grouped together in correspondence to each micro-lens does not need to form a rectangular shape and, instead, the plurality of light-receiving elements in the group may form shapes such as those shown in FIGS. 15 and 16. In the example presented in FIG. 15, light-receiving elements disposed closer to the edge of the micro-lens are not utilized so as to execute focus detection by using the maximum number of light-receiving elements present over the range in which light fluxes from the subject are not vignetted and the groups of light-receiving elements assume a substantially elongated circular shape in order to match the shapes of the two groups. Namely, when the shapes of the two groups match, a significant image shift quantity detection error attributable to a poor match of the two images used in the image shift comparison, which tends to occur if the images are blurred, does not manifest. It is to be noted that light-receiving elements may be grouped so as to increase the group area to utilize greater quantities of subject light fluxes at the cost of a good match with regard to the group shapes.

As described above, the focus detection device in the embodiment comprises the focus detection optical system (micro-lens array) 4 with a plurality of micro-lenses disposed on a plane, the focus detection sensor (light-receiving element array) 5 with a plurality of light-receiving elements disposed therein to receive light fluxes from the subject having been transmitted through the photographic lens (imaging optical system) 23 and the micro-lens array 4 and the focus detection calculation circuit 6 that determines through arithmetic operation the focal adjustment state of the photographic lens 2 based upon signals output from the focus detection sensor 5. At this focus detection device, the micro-lenses are disposed in various arrangements at the micro-lens array 4 in correspondence the positions assumed within the photographic image plane provided via the photographic lens 23. Consequently, the focus detection error attributable to the aberration of the photographic lens 23 can be minimized.

In addition, since the light-receiving elements are disposed in various arrangements on the focus detection sensor in correspondence to the positions assumed within the photographic image plane, the focus detection error attributable to the aberration of the photographic lens 23 can be reduced.

Furthermore, the image plane is partitioned into a plurality of detection areas and micro-lenses and light-receiving elements are disposed in each detection area along the radial direction extending from the center of the photographic image plane and a long the direction perpendicular to the radial direction. As a result, the focus detection error attributable to the aberration of the photographic lens 23 can be minimized while facilitating the production processes through which the focus detection optical system (micro-lens array) 4 and the focus detection sensor (light-receiving element array) 5 are manufactured.

In the embodiment and the variations described above, the micro-lenses are arrayed at the micro-lens array 4 along the radial direction extending from the image plane center and along the direction perpendicular to the radial direction by assuming specific arrangements (partial arrays) in correspondence to the positions assumed within the photographic image plane of the photographic lens 23, i.e., in correspondence to the individual detection areas A through O. The detection areas A through O include multiple detection areas assuming different partial arrays for the micro-lenses disposed therein. Namely, the micro-lens array 4 includes a plurality of partial areas in each of which micro-lenses are disposed in arrangements different form one another. As a result, the focus detection error attributable to the aberration of the photographic lens 23 can be minimized.

(Other Variations for the Pixel Array)

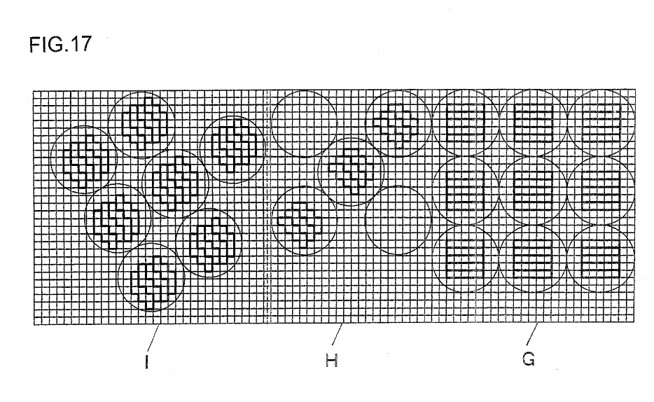

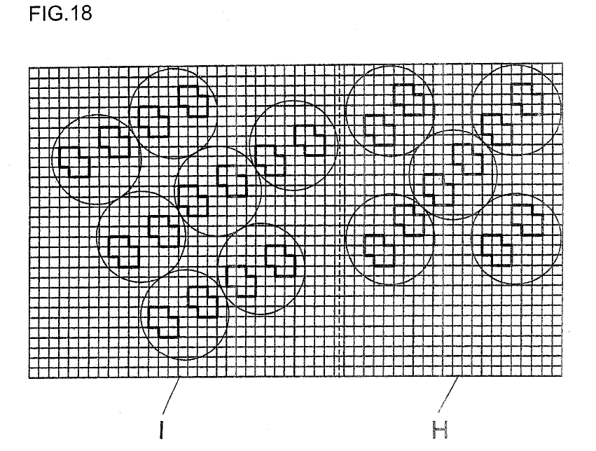

FIGS. 17 and 18 present other variations of the pixel array. It is to be noted that while the figures show the lower left detection areas (I, H, G) and (I, H) among the detection areas A through O in FIG. 5, similar arrangements are adopted in the other detection areas as well. In the pixel array shown in the figures the light-receiving elements are two-dimensionally disposed along the longitudinal direction and the lateral direction in all the detection areas, irrespective of the micro-lens disposing directions.

When detecting the image shift quantity indicating the extent of image shift along the radial direction extending from the image plane center, a plurality of light-receiving elements disposed under each micro-lens are grouped together as indicated by the bold lines in FIG. 17, and the outputs from the light-receiving elements in each group are added together to be used as a single light-receiving element output. In the detection area G, five light-receiving elements are grouped together, whereas seven light-receiving elements are grouped together to form a single group in the detection areas H and I. Unlike in the pixel arrays described earlier, the light-receiving elements making up a group may not be set along the direction accurately aligned with the radial direction extending from the image plane center depending upon the angle formed by the radial direction extending from the image plane center toward the center of the detection area I and the direction along which the light-receiving elements are set at the focus detection sensor 5 and thus, the groups may not assume identical shapes in the detection area I. However, the same method can still be adopted in the focus detection by grouping the light-receiving elements so as to satisfy the requirements through approximation. While FIG. 17 presents an example in which light-receiving elements achieving a large size relative to the diameter of the micro-lenses are used, better approximation can be achieved by using light-receiving elements in a smaller size.

When executing focus detection through the variation of the second focus detection calculation method explained earlier, whereby the outputs from a plurality of adjacent light-receiving elements are integrated and the integrated data are extracted to be used in the focus detection calculation, a plurality of light-receiving elements disposed in correspondence to each micro-lens may be grouped as indicated by the bold lines in FIG. 18. Then, by adding together the outputs from the light-receiving elements in each group to be used as a single light-receiving element output, “group strings” equivalent to the light-receiving element groups C and D shown in FIG. 3 can be generated.

As described above, light-receiving elements are disposed in a two-dimensional square array at the focus detection sensor (light-receiving element array) 5, the photographic image plane is divided into a plurality of detection areas and micro-lenses are disposed within each detection area along the radial direction extending from the photographic image plane center and along the direction perpendicular to the radial direction. In addition, a plurality of light-receiving elements disposed along the radial direction or the direction perpendicular to the radial direction, among the plurality of light-receiving elements corresponding to each micro-lens, are used in the focus detection. As a result, the focus detection error attributable to the aberration of the photographic lens 23 can be minimized while facilitating the production processes through which the focus detection sensor (light-receiving element array) 5 is manufactured.

(Other Variations)

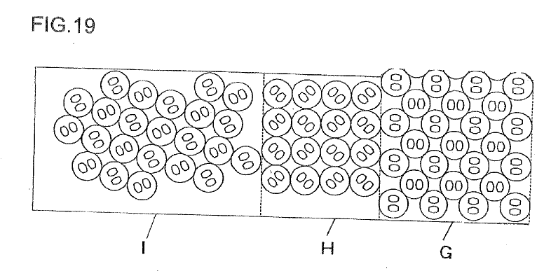

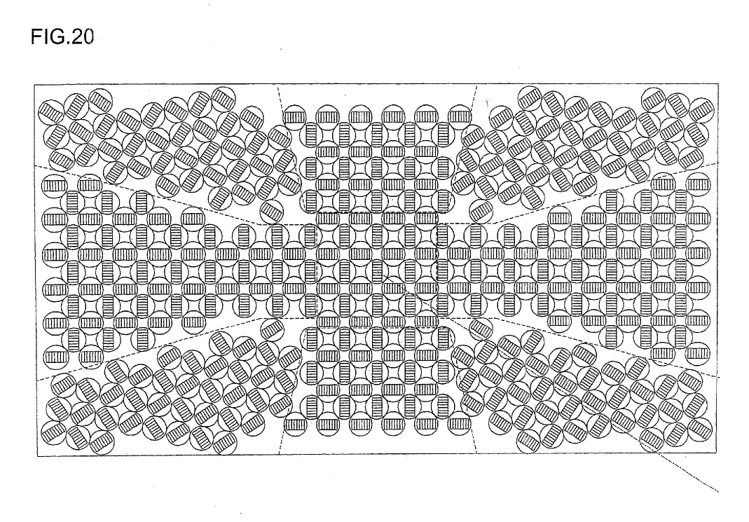

(1) The present invention may also be adopted in conjunction with a pixel array with two light-receiving elements disposed in correspondence to each micro-lens, as shown in FIG. 19. While FIG. 19 shows the pixel arrangements assumed in the detection areas G, H and I (see FIG. 5) only, similar pixel arrangements are adopted in the other detection areas as well. While the first focus detection calculation method cannot be adopted in this pixel array, focus detection can be executed through the second focus detection calculation method.
(2) In the embodiment described above, the boundary lines (dividing lines) that separate the detection areas from one another, as shown in FIG. 5, extend along the horizontal direction and along the vertical direction. However, the present invention is not limited to this example and the boundary lines separating the detection areas from one another may extend along diagonal directions or they may be staggered lines. For instance, by drawing the boundary lines separating the individual detection areas from one another as lines similar to the radial lines extending from the image plane center, as shown in FIG. 20, greater numbers of micro-lenses can be disposed in succession, which enables detection of the image shift quantity based upon images formed over significant ranges along the radial direction extending from the image plane center through the second focus detection calculation method. As a result, a greater extent of image shift can be detected, which, in turn, enables detection of a greater extent of defocusing.
(3) The focus detection sensor 5 may also output image data as well as the focus detection signals, and in such a case, the focus detection calculation circuit 6 may select a focus detection area to be used for the defocus amount calculation among the plurality of focus detection areas based upon detected characteristic portion of the image manifested by the image data input thereto. The contrast may be detected as the characteristic portion and the focus detection calculation circuit 6 using such characteristic portion should set the focus detection area at a position corresponding to an area where the contrast is indicated by a value equal to or greater than a predetermined value.

The above described embodiments are examples and various modifications can be made without departing from the scope of the invention.

What is claimed is:

1. A focus detection device, comprising:
a micro-lens array constituted of a plurality of micro-lenses that are two-dimensionally arrayed on a lens arrangement plane of the micro-lenses;
a light-receiving element array that includes a plurality of light-receiving elements disposed in correspondence to each micro-lens, and that receives a light flux from an imaging optical system via the micro-lens; and
a focus detection calculation unit that calculates a focal adjustment state of the imaging optical system based upon light reception signals output from the light-receiving elements at the light-receiving element array, wherein:
arrangements of the micro-lenses are different with each other in correspondence to area on a lens arrangement plane of the micro-lens array.

2. A focus detection device according to claim 1, wherein:
the micro-lens array and the light-receiving element array are disposed in correspondence to an image plane provided via the imaging optical system; and
the micro-lenses are disposed along at least one of a radial direction extending from a center of the image plane and a direction perpendicular to the radial direction extending from the center in each of a plurality of areas defined by partitioning corresponding the image plane of the micro-lens array.

3. A focus detection device according to claim 2, wherein:
arrangements of the light-receiving elements in the light-receiving element array are different with each other in correspondence to area on an element arrangement plane of the light-receiving element array.

4. A focus detection device according to claim 3, wherein:
the light-receiving elements are disposed along at least one of a radial direction extending from a center of the image plane and a direction perpendicular to the radial direction extending from the center in each of a plurality of areas defined by partitioning corresponding the element arrangement plane of the light-receiving elements.

5. A focus detection device according to claim 2, wherein:
the light-receiving elements are disposed in matrix on an element arrangement plane irrespective of the plurality of areas.

6. A focus detection device according to claim 2, wherein:
the plurality of areas are partitioned by a partitioning line extending along the radial direction extending from the center of the image plane.

7. A focus detection device according to claim 1, wherein:
the focus detection calculation unit determines the focal adjustment state based upon outputs of a plurality of light-receiving elements disposed along at least one of a radial direction extending from a center of an image plane and a direction perpendicular to the radial direction extending from the center, among the plurality of light-receiving elements corresponding to each micro-lens.

8. A focus detection device according to claim 1, wherein:
the plurality of light-receiving elements corresponding to each micro-lens includes a pair of light-receiving elements along an array direction of micro-lenses; and
the focus detection calculation unit determines the focal adjustment state based upon a pair of outputs from a plurality of light-receiving elements.

9. A focus detection device according to claim 8, wherein:
the focus detection calculation unit determines the focal adjustment state based upon the pair of outputs from a plurality of light-receiving element sets with translational symmetry along one of the radial direction extending from the center of the image plane and the direction perpendicular to the radial direction extending from the center, among the plurality of light-receiving elements included in the light-receiving elements corresponding to each micro-lens.

10. An imaging apparatus comprising the focus detection device according to claim 1.

11. An imaging apparatus according to claim 10, further comprising:
a detecting unit that generates image data by using light reception signals from the light-receiving elements and detects a position of characteristic portion in an image corresponding to the image data, wherein:
the focus detection calculation unit determines the focal adjustment state of the imaging optical system based upon light reception signals from the light-receiving elements corresponding to the position of the characteristic portion in the image.

12. A focus detection device, comprising:
a micro-lens array constituted with a plurality of micro-lens groups including a plurality of micro-lenses two-dimensionally arrayed;
a light-receiving element array that includes a plurality of light-receiving elements disposed in correspondence to micro-lens array, and that receives a light flux from an imaging optical system via the micro-lens array; and
a focus detection calculation unit that calculates a focal adjustment state of the imaging optical system based upon light reception signals output from the light-receiving elements at the light-receiving element array, wherein:
in part of the plurality of the micro-lens groups, the micro-lenses are disposed in a different arrangement.

13. A focus detection device, comprising:
a micro-lens array constituted with a plurality of micro-lenses that are two-dimensionally arrayed on a lens arrangement plane of the micro-lens array;
a light-receiving element array that includes a plurality of light-receiving elements disposed in matrix, which receives a light flux from an imaging optical system via the micro-lenses; and
a focus detection calculation unit that calculates a focal adjustment state of the imaging optical system based upon light reception signals output from the light-receiving elements at the light-receiving element array, wherein:
arrangements of the micro-lenses are different with each other in correspondence to area on a lens arrangement plane of the micro-lens array.

14. A focus detection device according to claim 13, wherein:
the micro-lens array and the light-receiving element array are disposed in correspondence to an image plane provided via the imaging optical system; and wherein
the focus detection calculation unit determines the focal adjustment state based upon a plurality of the light reception signals selected along one of a radial direction extending from a center of the image plane and a direction perpendicular to the radial direction extending from the center in correspondence to each of a plurality of areas defined by dividing an element arrangement plane of the light-receiving element array.

15. A method for manufacturing a focus detection device, comprising:
providing a light-receiving element array that includes a plurality of light-receiving elements disposed in matrix, which receives a light flux from an imaging optical system;
providing micro-lens array constituted of a plurality of micro-lenses that are two-dimensionally arrayed on a lens arrangement plane of the micro-lenses, arrangements of the micro-lenses being different with each other in correspondence to area on the lens arrangement plane of the micro-lens array;
disposing a plurality of the light-receiving elements on the light-receiving element array corresponding to each the micro-lenses; and
providing a calculation circuit calculating a focal adjustment state of the imaging optical system based upon light reception signals output from the light-receiving elements at the light-receiving element array.

16. A method for manufacturing a focus detection device according to claim 15, wherein:
the micro-lens array and the light-receiving array are disposed in corresponding to an image plane provided via the imaging optical system; and
the micro-lenses are disposed along at least one of a radial direction extending from a center of the image plane and a direction perpendicular to the radial direction extending from the center in each of a plurality of areas defined by partitioning corresponding the lens arrangement plane of the micro-lens array.

17. A method for manufacturing a focus detection device according to claim 16, wherein:
arrangements of the light-receiving elements in the light-receiving element array are different with each other in correspondence to area on an element arrangement plane of the light-receiving element array.

18. A method for manufacturing a focus detection device according to claim 17, wherein:
the light-receiving elements are disposed along at least one of a radial direction extending from a center of the image plane and a direction perpendicular to the radial direction extending from the center in each of a plurality of areas defined by partitioning corresponding the element arrangement plane of the light-receiving elements.

19. A focus detection method for detecting a focus state of an image formed by an imaging optical system, by means of a focus detection device according to claim 1 comprising:
determining the focal adjustment state based upon outputs of a plurality of light-receiving elements disposed along at least one of a radial direction extending from a center of an image plane and a direction perpendicular to the radial direction extending from the center, among the plurality of light-receiving elements corresponding to each micro-lens.

20. A focus detection method according to claim 19, wherein:
the focal adjustment state is determined based upon a pair of outputs from a plurality of light-receiving elements, the pair of outputs being in correspondence to a pair of light-receiving elements corresponding to each micro-lens along an array direction of micro-lenses.

21. A focus detection method according to claim 19, wherein:
the focal adjustment state is determined based upon the pair of outputs from a plurality of light-receiving element sets with translational symmetry along one of the radial direction extending from the center of the image plane and the direction perpendicular to the radial direction extending from the center, among the plurality of light-receiving elements included in the light-receiving elements corresponding to each micro-lens.

22. A focus detection method according to claim 19, further comprising:
generating image data by using light reception signals from the light-receiving elements;
detecting a position of characteristic portion in an image corresponding to the image data; and wherein
the focal adjustment state of the imaging optical system is determined based upon light reception signals from the light-receiving elements corresponding to the position of the characteristic portion in the image.
